(19) United States
(12) Patent Application Publication
(10) Pub. No.: US 2006/0265940 A1
(43) Pub. Date: Nov. 30, 2006

(54) Egg-shaped live bait well system

(75) Inventors: Joseph A. McAleer JR., Gulf Shores, AL (US); Don A. Druse, Fairhope, AL (US)

Correspondence Address: THE WEBB LAW FIRM, P.C., 700 KOPPERS BUILDING, 436 SEVENTH AVENUE, PITTSBURGH, PA, 15219, US

(73) Assignee: McAleer Marine Group, LLC, Foley, AL (US)

(21) Appl. No.: 11/415,944

(22) Filed: May 2, 2006

Related U.S. Application Data
(60) Provisional application No. 60/676,871, filed on May 2, 2005.

(51) Int. Cl. A01K 97/05

(52) U.S. Cl. 43/57

(57) ABSTRACT

A live bait well for storing and maintaining live bait includes a container having an egg shape. The container includes a top lid connected by a hinge to a main body and a water tight seal provided by a gasket. The container includes molded cooling device holders and a drain. A water purification system is provided that includes a pump and an oxygen aerator infusion device and a charcoal filter in line in a tube system connected to an outlet port and an inlet port of the main body of the container.

### CROSS REFERENCE TO RELATED APPLICATIONS

This application claims priority from U.S. Provisional Patent Application No. 60/676,871, filed May 2, 2005, which is incorporated herein by reference.

### BACKGROUND OF THE INVENTION

1. Field of the Invention

The invention relates generally to a live bait well and specifically an egg-shaped live bait well for use by anglers.

2. Description of Related Art

In the art of fishing, minnows, shrimp and other types of bait are contained in live bait wells. The purpose of any live bait well is to kept the bait alive for use to catch fish for the duration of a fishing excursion. Various types of live bait wells are known and used in art. For example, U.S. Pat. No. 4,184,281 entitled “Live Bait Well” to Corby et al. teaches a bait well in the form of a circular tub-shaped body with a concentric sleeve that defines an annular water compartment, which fits below a fisherman's chair on a boat.

Additionally, combination bait and live wells are gaining in popularity. The purpose of the live and bait well is two-fold, namely to keep bait and fish, which are caught, temporarily alive for the duration of a fishing trip. Various types of live and bait wells are known and used in the art. For example, U.S. Pat. No. 4,970,982 entitled “Combination Livewell and Bait Well for Fishing Boats” to Martin teaches a bait well in the form of a bucket and a livewell in the form of square tank combined into a built-in tank on a fishing boat. The built-in tank includes an aeration device and pump for continuously pumping water from outside the boat into and through the tank. In addition, U.S. Pat. Nos. 5,822,916 and 6,101,759, both entitled “Electronically Automated Portable Live and Bait Well” to Power, teach a storage container with a bait compartment and a live fish compartment, a portable version of the storage container and a method for keeping fish alive in the storage container. The storage container is square shaped with an electronic control panel used to control a pump for filling, emptying, recycling and aerating water in the storage container.

Keeping live bait alive and active in a live bait well can be a difficult task for fishermen, who rely on the bait to stay alive for a partial or a whole day, or even several days for fishing. Live bait, such as small fish, shrimp and other types of bait, requires unique considerations for the best means to prevent expiration before use. Specifically, live shrimp, which is preferred by salt and brackish water fishermen, is recognized as the most difficult bait to keep alive and active for use. Although useful in maintaining live bait for fishing excursions, the prior art live bait wells and combination live and bait wells have limitations.

Research indicates that four factors contribute to the difficulties faced by fishermen in maintaining live and active bait in live bait wells. The four factors are the shape of the live bait well, the oxygen levels of the water in the live bait well, the temperature of the water in the live bait well, and the level of solid waste in the water of the live bait well resulting from excretion from the live bait. If not recognized and addressed, the four factors prove to be the most common reasons for the demise of live bait, which causes lost productivity by recreational and professional fishermen on the water.

The shape of the live bait well is a critical factor for several reasons. The prior art teaches that modern live well containers have one of several configurations: cylindrical (bucket shape), oval and square. One problem with the modern well shapes is the flat surface areas presented on the top and bottom of the cylindrical- and oval-shaped wells, and the top, bottom and sides of the square-shaped wells. When operating a boat with a live bait well in choppy or rough water conditions, and even when carrying a portable bait container to a fishing area, the live bait tends to be slammed against the flat surfaces of the live bait well. The slamming force leads to extensive damage and shock to the bait, and more often than not death of any type of live bait. Another problem with the commonly used well shapes is the tendency for settling of suspended particulate matter in the water, which provides an environment that facilitates the growth of pathogenic bacteria in the water.

The oxygen level in the water in the live bait well is also a critical factor. Most types of bait are aquatic species that obtain oxygen from water. The level of oxygen in water in live bait wells is related directly to the amount of bait the water can support and the duration the bait can be kept alive. One problem with modern live bait wells is the reduced levels of, or the lack of replenishment of, oxygen in the water. The practice of infusing oxygen into water in live bait wells is becoming more common with implementation of aeration pumps in more extensive, modern live bait wells sold on the market.

Another critical factor is the temperature of the water in the live bait well. A majority of fishing occurs during warm to hot weather periods of the year. The temperature of the external environment directly affects the survival of the live bait held in live bait wells. One problem with modern live bait wells is the increase of the temperature of the water. Fishermen have tried several techniques to maintain cool water levels in live bait wells. A common feature of the techniques involves the introduction of ice into the live bait well or adjacent the live bait well. However, introducing loose ice into the water in a live bait well creates an environment that is cold and fatal to the bait. Additionally, introducing a bag of ice or frozen container into live bait wells presents problems with the temperature of water in the live bait well and with the presence of a movable object that can strike and kill bait.

Yet another critical factor is the level of solid waste in the water of the live bait well. Naturally and expectedly, waste is excreted by live bait into water in the live bait well. Ammonia and other toxins in waste build up to high concentrations in water in live bait wells. Specifically, live shrimp discharge solid and fluid waste that adds large quantities of ammonia into the water. The presence of ammonia and other toxins in waste from live bait is a problem that is common to all live bait wells sold on the market. The ammonia and other toxins are deadly to any species of live bait in the live bait well.

Accordingly, there is a present need for a live bait well comprising an egg-shaped container with molded external ice packet holders and a water purification system having a pump and oxygen infusion aerator device with a charcoal purification filter, all of which address the problems of the prior art.

### SUMMARY OF THE INVENTION

The present invention provides a live bait well comprising an egg-shaped container with molded external ice packet holders and a water purification system having a pump and oxygen infusion aerator device with a charcoal purification filter.

Generally, the container of the live bait well is three-dimensional with an egg-shaped container with a smooth, rounded interior surface. The container comprises a top lid capable of a water tight seal with the main body of the container. The top lid is connected with a hinge so that the top lid can flip open to provide an opening to load water and live bait into the body of the live bait well. When the container of the live bait well is closed, the top lid is secured with a latch to the main body of the live bait well. A gasket is provided between the top lid and the main body of the container to form a watertight seal. A drain hole provides fluid communication through the bottom of the main body of the container for draining fluid.

The water purification system of the live bait well comprises a pump and oxygen infusion aerator device and tube system. In operation, drawing from water inside the lower portion of the main body of the container, the pump and oxygen infusion aerator device infuses microscopic air bubbles into the water. The pump then forces the oxygen-enriched water through an inline charcoal filtration system for purification. The oxygen-enriched, purified water is then pumped by the pump through a tube, back into the upper portion of the egg-shaped container to replenish the volume of water in the container.

Ice packet holders are provided with the live bait well. The ice packet holders are molded into the external surface of the live bait well and provide receiving spaces for ice used to cool the water and live bait inside of the live bait well.

The live bait well is provided as either a built-in version in a boat or a portable version. The built-in version of the live bait well is adapted for housing in a deck of a boat. The portable version of the live bait well is transportable as an independent unit.

### BRIEF DESCRIPTION OF THE DRAWING

FIG. 1 is an elevated view of a live bait well of the present invention.

### DETAILED DESCRIPTION OF THE INVENTION

The disclosure of the present invention is illustrative and exemplary of the invention and is made for purposes of providing a full disclosure of the invention. Additional embodiments, adaptations, variations, modifications and equivalent arrangements will be apparent to those skilled in the art. In reference to the disclosure of the invention, similar references to similar parts are used uniformly throughout the disclosure of a live bait well 20. The live bait well 20 can be used by fisherman to keep bait alive in a cool oxygen-enriched, contaminant-reduced, contained environment, lacking flat surfaces for bait to encounter.

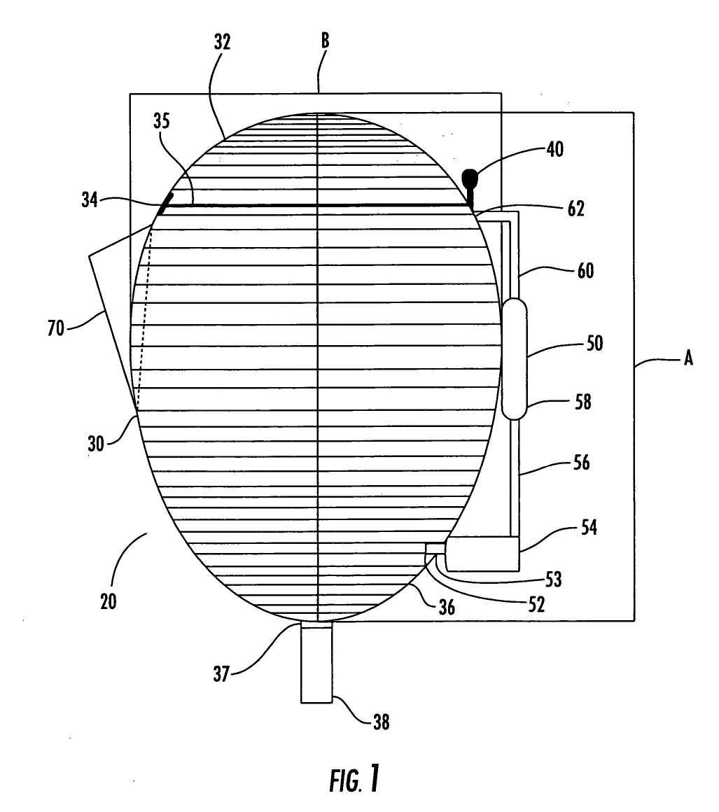

Referring to FIG. 1, the live bait well 20 provided by the present invention comprises a container 30 having a three-dimensional, egg shape and water purification system 50 comprising an external pump and oxygen infusion aerator device 54 and tube system. The three-dimensional, egg-shaped container 30 and water purification system 50 of the live bait well 20 embraces the four critical issues inherent for keeping bait alive in a live bait well 20. Particularly, the live bait well 20 of the present invention provides configurations relating to an optimized shape of the live bait well 20, oxygen-enriched water in the live bait well 20, and reduced temperatures and levels of solid waste in the water within the live bait well 20. The optimal configurations of the live bait well 20 overcome the problems associated with the prior art live bait wells. The live bait well 20 can be configured as a build-in system in a boat or, alternatively, as a portable system.

Generally, the live bait well 20 provides a container 30 with a three-dimensional, egg shape as shown in FIG. 1. A top lid 32 is attached with a hinge 34 to the main body 36 of the container 30 to provide the three-dimensional, egg-shaped container 30. The container 30 can be manufactured from polypropylene or any other suitable material known by skilled artisans. The interior surface of the container 30 provides a smooth, rounded surface, absent any flat surface, which defines the interior chamber of the container 30. The hinge 34, which attaches the top lid 32 to the main body 36 of the container 30, allows the top lid 32 to move between an open position and a closed position shown in FIG. 1. When the container 30 is in an open position, the top lid 32 is flipped open to provide access to the interior chamber of the container 30 for various reasons such as loading water and live bait into the interior chamber of the container 30 and accessing live bait stored within the interior chamber of the container 30 of the live bait well 20. Alternatively, when the container 30 is in the closed position as shown in FIG. 1, the top lid 32 is closed against the main body 36 of the container 30 and secured with a latch 40 to the main body 36 of the container 30 to ensure that the container 30 remains closed, especially during use. A rubber gasket 35 is positioned between the top lid 32 and the main body 36 of the container 30 of the live bait well 20 to provide a seal that is water tight.

In the embodiment of the live bait well 20 shown in FIG. 1, the dimensions of the container 30 are twenty-eight inches along its longitudinal axis A and eighteen inches at its largest diameter B. With these particular dimensions of the aforementioned embodiment, the internal chamber of the container 30 provides a volume capable of holding approximately twenty gallons of water. In alternative embodiments of the container 30, many dimensions are provided for a wide variety of container sizes so long as the container shape conforms generally to a three-dimensional, egg shape. A skilled artisan will know corresponding longitudinal axis A and diametric dimensions that will be consistent with the intended variety of sizes of embodiments of the present invention.

Referring to FIG. 1, when the container 30 is in a closed position, the internal surface of container 30 is smooth and mostly rounded, absent any flat surfaces. The shape and characteristics of the interior surface of the container 30 serve several purposes. First, the movement of water within the container 30 creates a natural vortex. The natural vortex, in part, contributes to the high quality of water contained within the interior chamber of the container 30 of the live bait well 20. The vortex motion relates to the movement of water within the interior chamber of the container 30 and against the interior surface of the container 30 and settlement of particulate matter contained within the water in the interior chamber of the container 30. The continuous vortex motion slows the growth of pathogenic bacteria, which contaminates water, and also allows for cooling of the water to maintain a generally consistent water temperature throughout the container 30. Second, the interior shape of the container 30 allows for the movement of live bait in a natural motion in the water within the interior chamber of the container 30. The movement of the live bait within the interior chamber of the container 30 is devoid of the typical injurious and fatal pounding of live bait against edges, flat surfaces or other obstructions present in the prior art bait wells.

A drain hole 37 is provided in the bottom of the main body 36 of the container 30 of the live bait well 20. An external drain nozzle 38 is attached to the drain hole 37. The drain hole 37 provides fluid communication through the bottom of the main body 36 of the container 30. The drain nozzle 38 is an extension of the drain hole 37 and directs the flow of water or other fluid out of the container 30 of the live bait well 20. In particular, the drain hole 37 and drain nozzle 38 are used for draining fluid, which may contain large particulate matter such as solid waste excreted from live bait, from the container 30 without having to overturn the live bait well 20. The drain hole 37 and the drain nozzle 38 provide an additional component that aids in the purification of water in the live bait well 20. During cleaning, the drain hole 37 and the drain nozzle 38 may also be used to drain water and a mix of water and cleaning solution from the live bait well 20. The drain nozzle 38 can be connected with a drain tube to further direct the drainage of water from the live bait well 20 into a bilge or other depository. An additional pump may be configured with the drain tube to pump water drained from the live bait well 20 overboard.

Generally, a water purification system 50 is provided with the live bait well 20 as shown in FIG. 1. The water purification system 50 comprises a pump and oxygen infusion aerator device 54 and a charcoal filter 58, all external to the container 30 of the live bait well 20. An outlet port 52 of the container 30 provides fluid communication through the container 30 in the lower portion of the main body 36 of the container 30. A piece of tube 53 or pipe connects the outlet port 52 of the container 30 with the inlet of the pump and oxygen infusion aerator device 54 of the water purification system 50. The outlet of the pump and oxygen infusion aerator device 54 is connected by a piece of tube 56 or pipe to an inlet of the charcoal filter 58. Another piece of tube 60 or pipe connects the outlet of the charcoal filter 58 with an inlet port 62 of the container 30. The inlet port 62 provides fluid communication through the upper portion of the main body 36 of the container 30, below the top lid 32 of the container 30.

During operation of the water purification system 50, the pump and oxygen infusion aerator device 54 draws water from the lower portion of the main body 36 of the container 30 through the outlet port 52 and into the pump and oxygen infusion aerator device 54. A suitable pump and oxygen infusion aerator device 54 is commercially available and known by skilled artisans. Water is enriched with oxygen with the pump and oxygen infusion aerator device 54, which pumps microscopic bubbles into the water. The oxygen-enriched water may have up to 80% oxygen saturation. The power source for the pump and oxygen infusion aerator device 54, which operates on DC voltage, can be the 12V DC battery on a boat. Alternatively, the power source for the pump and oxygen infusion aerator device 54 is a rechargeable 12V DC battery similar to those used on cordless power tools. The power source for the portable version of the live bait well 20 will have a plug-in charger for recharging.

After enriching the water with oxygen, the pump and oxygen infusion aerator device 54 will pump the water through a piece of tube 56 or pipe to the charcoal filter 58 of the water purification system 50. The water is pumped through the charcoal filter 58 for purification. The charcoal filter 58 comprises a commercially available charcoal cartridge known to a skilled artisan. The charcoal cartridge of the charcoal filter 58 can be easily removed, cleaned and flushed before and after use. The charcoal cartridges are inexpensive to replace. The charcoal filter 58 removes particulate matter and other suspended impurities, such as ammonia and other excreted toxins and microscopic bacteria. After exiting the charcoal filter 58, the oxygen-enriched, purified water is pumped through another piece of tube 60 or pipe to the inlet port 62 in the upper portion of the main body 36 of the container 30 of the live bait well 20. The inlet port 62 communicates the enriched, purified water into the container 30 to replenish water drawn through the outlet port 52 of the container 30 by the water purification system 50. The circulation of water with the water purification system 50 can be set at variable time intervals known by skilled artisans to purify water in a timely fashion to support the volume of the live bait in the live bait well 20. The drawing of water from the bottom portion of the main body 36 of the container 30 by the water purification system 50 also contributes to the natural vortex of water within the interior chamber of the container 30 of the live bait well 20.

Ice packet holders 70 are molded into the exterior surface of the main body 36 of the container 30 of the live bait well 20. The ice packet holders 70 are configured for easy insertion and holding of Blue Ice® packets, ice or other cooling agent against the exterior surface of the main body 36 of the container 30 to cool the water within the interior chamber of the container 30. The Blue Ice® packets, ice or other cooling agent function to cool the water within the interior chamber of the container 30. The cooled water mixes with other water within the interior chamber of the container 30 through dynamic action of the natural vortex and the circulation of water through the container 30 by the water purification system 50. Portable models of the live bait well 20 can be placed inside of an insulated compartment with an electric cooling mechanism, such as a refrigerator, or an insulated container, such as a cooler, where bagged ice may be poured around the outside of the container 30. The various cooling mechanisms reduce heat exposure that adversely affects live bait in the live bait well 20.

Overall, the live bait well 20 provides a live bait storage device, and method of use thereof, that specifically addresses the four critical factors associated with use of the prior art live bait wells. Specifically, the shape of the container 30 is absent any flat surface so that live bait can move around within water in the interior chamber of the container 30 without pounding against a flat surface or other protrusion during use of the live bait well 20. The live bait well 20 provides a water purification system 50 that functions to circulate water through the container 30 while enriching the water with oxygen to support the live bait, to purify water in the live bait well 20 with a charcoal filter 58 by removal of solid waste and other toxins from the water, and to maintain a consistent, viable temperature of water in the interior chamber of the live bait well 20.

The invention has been described with reference to the preferred embodiment. Obvious modifications and alterations will occur to others upon reading and understanding the preceding detailed description. It is intended that the invention be construed as including all such modifications and alterations insofar as they come within the scope of the appended claim or the equivalents thereof.

The invention claimed is:

1. A live bait well for storing and maintaining live bait, the well comprising a container having an egg shape, wherein the container comprises a top lid connected with a hinge to the main body with a watertight seal provided by a gasket, and wherein the container comprises molded cooling device holders and a drain, and a water purification system comprising a pump and oxygen aerator infusion device and a charcoal filter in line in a tube system connected to an outlet port and an inlet port of the main body of the container.
